(19) United States
(12) Patent Application Publication
(10) Pub. No.: US 2009/0245036 A1
(43) Pub. Date: Oct. 1, 2009

(54) SERVO CONTROL DEVICE, SERVO CONTROL METHOD, AND SERVO CONTROL PROGRAM

(76) Inventor: Takashi Nakamura, Saitama (JP)

Correspondence Address: DRINKER BIDDLE & REATH (DC), 1500 K STREET, N.W., SUITE 1100, WASHINGTON, DC, 20005-1209, US

(21) Appl. No.: 12/161,637

(22) PCT Filed: Jan. 18, 2007
(86) PCT No.: PCT/JP2007/050651

§ 371 Date: Mar. 3, 2009

(30) Foreign Application Priority Data
Jan. 24, 2006 (JP) 2006-015669

(51) Int. Cl. G11B 7/00

(52) U.S. Cl. 369/44.11; G9B/7

(57) ABSTRACT

A servo control device that is capable of optimizing gain that is used in servo control and stabilizing the servo control even when the gain changes due to change in the status of overrecording over the same radial position on an optical disc. When drawing a visible image on the label surface of an optical disc DK by an overrecording operation over the same radial position of that label surface, the servo control device comprises a CPU 8 that changes the gain used in the servo control to correspond with the number of times that overrecording is performed over the same position on that label surface.

### TECHNICAL FIELD

The present invention is related to a servo control device, servo control method and servo control program, and more particularly, is related to a servo control device, servo control method and servo control program that records information over the same position on a recording medium such as an optical disc.

### BACKGROUND ART

In the field of optical discs on which information is optically recorded or from which information is optically reproduced using a light beam, technology has been developed in recent years in which a light beam for recording or reproducing information to or from an optical disc is used to draw visible text or graphics on the surface of an optical disc (hereafter, this surface will be referred to as the label surface) that is opposite the side (hereafter, this surface will be referred to as the information recording surface) on which the light beam is irradiated.

In this technology, by changing the intensity of the light beam that is irradiated on one circumferential portion at an identical radial position on the label surface according to the shape of the graphic or the like that is to be drawn on the label surface, the reflectivity of visible light at that position changes, and from that, text, graphics or the like are visibly drawn by changes in gradation. Furthermore, in addition to this, by performing control of intensity changes a plurality of times for one circumferential portion (plurality of rotations), it is possible to obtain a high degree of contrast as a graphic or the like.

Moreover, so-called overrecording is performed by performing a plurality of rotations of irradiation for one circumferential portion at that same radial position, however, in this case, the intensity of reflected light of the light beam changes in the same way as in the case of visible light described above at the same radial position due to the number of times of overrecording.

Therefore, the amplitude of the various error signals that are generated based on the intensity of the reflected light fluctuates according to the number of times the overrecording is performed, so as a result, so-called focus servo control and tracking servo control become unstable when executing overrecording, thus countermeasures to correct this problem are desired.

Typical countermeasures against the instability in various kinds of servo control is disclosed in Patent Document 1. [Patent Document 1] JP H9-282785.

### DISCLOSURE OF THE INVENTION

### Problems to be Solved by the Invention

However, conventional instability countermeasures have a problem in that they do not take into consideration ‘overrecording at the same radial position’, and they cannot be applied to the technology of drawing on the label surface describe above, therefore technology for stabilizing servo control that is used in the drawing technology described above is desired.

Taking into consideration the aforementioned problems, it is the object of the present invention to provide a servo control device, servo control method and servo control program that are capable of optimizing servo control gain and stabilizing that servo control even though the servo control gain fluctuates due to change in the status of overrecording at the same radial position on an optical disc.

### Means for Solving the Problems

To overcome above-mentioned problems, the present invention according to claim 1, a servo control device that performs servo control of overrecording at the same position on a recording medium, is provided with: a gain change device for changing the gain during the servo control to correspond with the status of the overrecording on the recording medium.

To overcome above-mentioned problems, the present invention according to claim 8, a servo control method for controlling an overrecording operation over a same position on a recording medium, is provided with: a gain change process that changes the gain in the servo control to correspond to the status of the overrecording on the recording medium.

To overcome above-mentioned problems, the present invention according to claim 9, a servo control program that causes a computer to function as the servo control device of any one of the claims 1 to 7.

### BRIEF DESCRIPTION OF THE DRAWINGS

FIG. 1 is a block diagram showing the construction of a graphics drawing device of a first embodiment of the present invention.

FIG. 2 is a flowchart showing the operation of a graphics drawing device of a first embodiment of the invention.

FIG. 3 is a drawing that conceptually shows the operation of a graphics drawing device of a first embodiment.

FIG. 4 is a flowchart showing the operation of a graphics drawing device of a second embodiment of the invention.

FIG. 5 is a drawing that conceptually shows the operation of a graphics drawing device of a second embodiment.

### DESCRIPTION OF REFERENCE NUMERALS

1 Spindle motor
2 Rotation migration unit
3 Counter
4 Pickup
5 Driver
6 Equalizer
7 Error signal generation unit
8 CPU
B Light beam
SB Graphics drawing device
DK Optical disc

### BEST MODE FOR CARRYING OUT THE INVENTION

Next, the preferred embodiments of the present invention will be explained based on the drawings. Each of the embodiments described below are embodiments in which the present invention is applied to a graphics drawing device that uses as is a light beam, which is originally intended to be used to record information onto an optical disc that is to be reproduced, to draw a preset visible image on the label surface of the optical disc.

### (I) First Embodiment

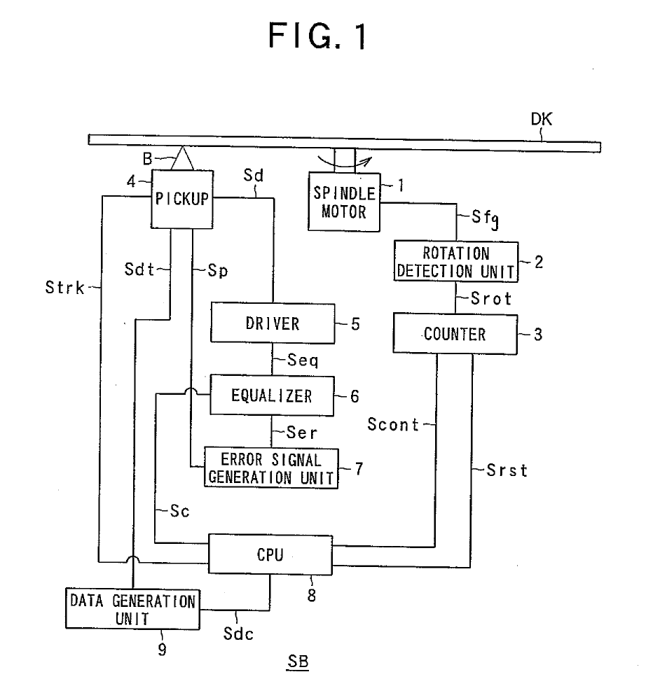

First, a first embodiment of the present invention will be explained using FIG. 1 to FIG. 3.

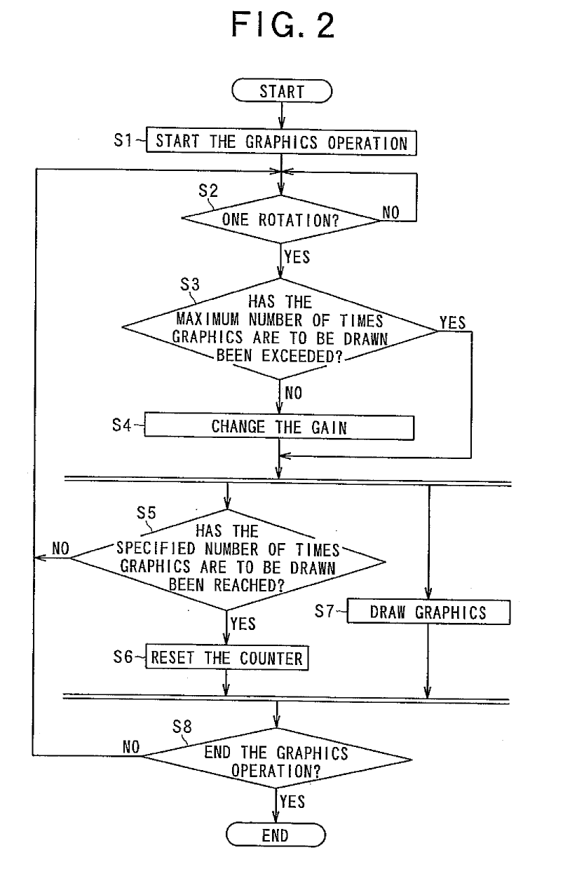

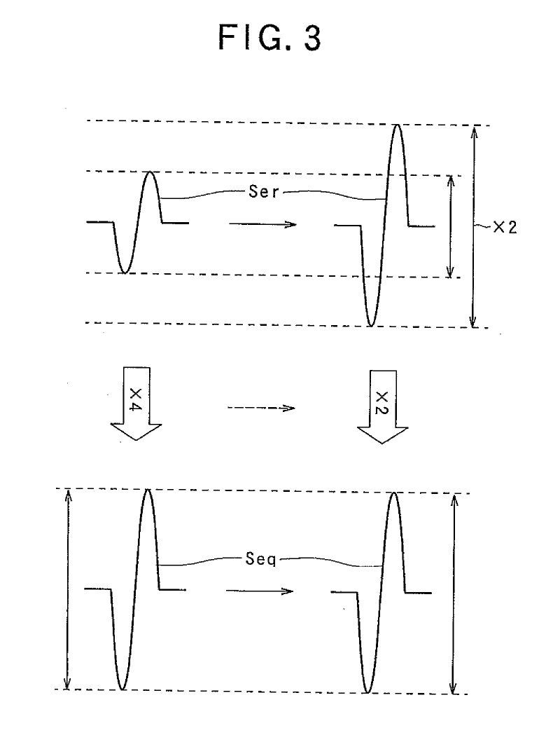

FIG. 1 is a block diagram showing the construction of a graphics drawing device of a first embodiment of the present invention, FIG. 2 is a flowchart showing the operation of the graphics drawing device, and FIG. 3 is a drawing that conceptually shows the operation of the graphics drawing device. Here, the graphics drawing device of this first embodiment comprises the fundamental functions as an information-recording device that records information onto the information recording surface of an optical disc DK that is used as a recording medium. Moreover, FIG. 1 is a block diagram that extracts and shows only the parts of the information recording device that function as the graphics drawing device of this first embodiment.

As shown in FIG. 1, the graphics drawing device S of this first embodiment comprises: a spindle motor 1 that rotates an optical disc DK that is secured so that a light beam B such as laser beam or the like is irradiated onto the label surface of the disc; a rotation detection unit 2; a counter 3 as a counting means; a pickup 4 that irradiates the light beam B toward the label surface with a constant intensity; a driver 5; an equalizer 6 as a gain conversion means; an error signal generation unit 7; a CPU 8 and a data generation unit 9.

Next, the overall operation will be explained.

The spindle motor 1 that rotates the optical disc DK outputs a rotation angle signal Sfg, which indicates the angle of rotation of the disc, to the rotation detection unit 2.

From this, based on the rotation angle signal Sfg, the rotation detection unit 2 calculates the angle of rotation of the optical disc DK from a rotation angle position that is preset as a reference, and each time the optical disc DK rotates, the rotation detection unit 2 generates a rotation signal Srot that indicates that the disc has made one rotation and sends that signal to the counter 3.

The counter 3 is reset by a reset signal Srst (described later) from the CPU 8, and by calculating the number of times that the rotation signal Srot has been output, the counter 3 generates a rotation count signal Scont that indicates the number of rotations of the optical disc DK, and outputs that signal to the CPU 8.

At the same time as this, based on a movement signal Strk from the CPU 8, the pickup 4 moves in the radial direction of the optical disc DK, and based on a drive signal from a drive unit (not shown in the figure), the pickup 4 irradiates the light beam B onto the label surface of the optical disc DK. The pickup 4 then receives the reflected light of that irradiated light beam B from the optical disc DK, generates a received light signal Sp having an amplitude that corresponds to the intensity of that received light, and outputs that signal to the error signal generation unit 7.

After that, the error signal generation unit 7 generates an error signal Ser that includes a tracking error signal and focus error signal that are the same as in the case of when information is optically recorded on the information recording surface of the optical disc by the light beam B, and outputs that error signal Ser to the equalizer 6.

Moreover, based on a control signal Sc from the CPU 8, the equalizer 6 changes the gain of the error signal Ser, and outputs the error signal Ser after the gain has been changed to the driver 5.

The driver 5 then executes focus servo control and tracking servo control for the focus position on the label surface of the optical beam B in the same way that information was optically recorded on the information recording surface of the optical disc DK by the light beam B, and based on the equalizer signal Seq, the driver 5 generates a drive signal Sd for driving the focus actuator and tracking actuator (not shown in the figure) of the pickup 4, then outputs that signal to each actuator.

On the other hand, the data generation unit 9 generates data that corresponds to an image that is to be drawn on the label surface, and based on a control signal Sdc from the CPU 8, the data generation unit 9 resolves the data to rotation data that corresponds to one circumferential portion at each radial position on the optical disc DK and outputs the result to the pickup 4.

Moreover, the CPU 8 outputs the reset signal Srst as needed to the counter 3, and based on the calculated result of that counter 3, performs overall control of the gain change operation of this first embodiment by generating the aforementioned control signal Sc for controlling the equalizer 6 to change the gain of the error signal Ser, and outputting that control signal Sc to the equalizer 6, and by generating the aforementioned control signal Sdc to cause the data generation unit 9 to output data.

Next, the graphics operation, including the gain change operation, of this first embodiment of the invention, will be explained in detail using FIG. 2 and FIG. 3.

In the graphics operation of this first embodiment that will be explained below, the irradiation position of the light beam B is moved in the radial direction in units of rotation by the same tracking servo control as in the case of optically recording information on a recording track that is formed on the information recording surface of the optical disc DK, and by rotating the optical disc DK itself and irradiating the light beam B on the label surface of that optical disc DK to incrementally change the color of coating that was applied beforehand to the label surface, a visible graphic is drawn on the label surface.

When doing this, the surface underneath the coated color surface of the optical disc DK is a mirror surface, and when performing overrecording that irradiates the light beam B a plurality of revolutions for one circumferential portion at the same radial position on the optical disc DK, graphics are drawn by changes in gradation that occur by changing the number of times that overrecording is performed according to the radial position.

In other words, as shown in FIG. 2, in the graphics operation of this first embodiment, after a data signal Sdt from the data generation unit 9 begins to be output (step S1), the CPU 8 constantly monitors whether or not the optical disc DK has rotated one time based on the rotation signal Srot from the rotation detection unit 2 (step S2). When the optical disc DK has not yet made one rotation (step S2: NO), the CPU 8 continues monitoring until one rotation is complete, however, when one rotation is complete (step S2: YES), the CPU 8 determines whether or not the total number of rotations at the timing when that one rotation is complete (that is, the number of overrecordings performed for that radial position) exceeds a preset maximum number of times graphics can be drawn on the label surface of that optical disc DK (step S3).

Here, the maximum number of times graphics can be drawn is a preset set number of times that overrecording can be performed before all the color on the label surface of the optical disc DK of this first embodiment completely changes. Moreover, when the number of overrecordings exceeds this number and the gain of the error signal Ser continues to be changed by processing as will be described later, the gain will continue to change even though that position on the label surface is nearly a mirror state, so the gain will be changed too much. Therefore, in order to prevent errors in focus servo control from occurring due to excessive change in the gain, the upper limit for the number of times that overrecording can be performed is a value that limits the number of times that overrecording can be performed as the maximum number of times that graphics can be drawn.

In the judgment of step S3, when the detected number of times that overrecording has been performed exceeds the maximum number of times graphics can be drawn (step S3: YES), the gain of the error signal Ser is not changed, and processing advances to steps S5 and S7 (to be described later).

However, in the judgment of step S3, when the detected number of times that overrecording has been performed is equal to or less than the maximum number of times graphics can be drawn (step S3: NO), the gain of the error signal Ser changes by an increment according to control from the CPU 8 and equalizer 6 (step S4).

In the case of the label surface of the optical disc DK of this first embodiment, as the gain changes, the reflectivity of the light B increases as the number of time overrecording is performed increases (in other words, the label surface approaches becoming a mirror surface), so each time the number of times overrecording is performed increases by one time, the gain of the error signal Ser is decreased just an experimentally preset value. On the other hand, in the case of another kind of optical disc DK having construction such that the reflectivity of the light beam B on the label surface decreases as the number of times overrecording is performed increases, then opposite the case in step S4, each time the number of times overrecording is increased by one time, the gain of the error signal Ser increases.

After the gain of the error signal Ser has been changed in step S4, the CPU 8 uses the changed gain to perform focus servo control and tracking servo control and to draw graphics on the label surface (step S7).

At the same time as the operation of step S7, the CPU 8 checks whether or not the current number of rotations of the optical disc DK has reached the number of times for overrecording that was preset for that radial position according to the relationship with the overall image that is to be drawn on the label surface (step S5). When the number of rotations has reached the set number of times for overrecording (step S5: YES), the CPU 8 initializes the count value of the counter 3 (step S6), then next checks whether or not the overall graphics operation for the label surface is complete (step S8).

Moreover, when the graphics operation is complete (step S8: YES), the graphics operation of this first embodiment ends, however, when there is still data corresponding to the image that has yet to be drawn (step S8: NO), processing returns to step S2 in order to draw the image for the next rotation portion, and the series of operations described above are executed for that next rotation.

On the other hand, in the judgment of step S5, when the number of times counted by the counter 3 has not reached the number of times overrecording is to be performed, the light beam B continues to be further irradiated at the same radial position, and the CPU 8 returns to the processing of step S2 without resetting the count of the counter 3, and continues to perform overrecording for that same radial position.

As was explained above, with the operation of the graphics drawing device SB of this first embodiment, the gain in servo control changes in correspondence to the number of times that overrecording is performed for the same radial position on the label surface of the optical disc DK, so even though the gain fluctuates due to changes in the number of times overrecording is performed, it is possible to optimize the gain and stabilize the servo control.

More specifically, as shown at the top of FIG. 3, by proceeding with overrecording for the same radial position, even though the reflectivity at that radial position increases and the amplitude of the error signal increases to double the size, the equalizer 6 sets the gain to half to correspond to this, so as a result, as shown at the bottom of FIG. 3, the amplitude of the equalizer signal Seq does not change.

Moreover, the gain is changed so that the amplitude of the error signal Ser is constant even though the number of times that overrecording is performed increases, so it is possible to stabilize servo control even though the number of times overrecording is performed fluctuates.

In addition, the number of times overrecording is performed for the same radial position on the optical disc DK is counted and the gain is changed, so it is possible to stabilize servo control with very simple construction.

Furthermore, when overrecording is performed a greater number of times than the maximum number of times graphics are to be drawn, the gain value is fixed at the gain value that corresponds to the maximum number of times graphics are to be drawn, so even though overrecording may be executed a number of times greater than the maximum number of times graphics are to be drawn, it is possible to prevent the gain from changing excessively and to stabilize the servo control.

A typical parameter that must be considered when presetting the value of the maximum number of times graphics are to be drawn that is used in the judgment of step S3 is the intensity of the light beam B itself, however, in addition to this, the oscillation frequency of the tracking actuator when drawing graphics at the same radial position on the label surface (or in other words, the frequency at which a light spot that is formed on the label surface by the light beam B when drawing graphics oscillates in the radial direction of the light beam B) can also be considered.

In this case, in order that the graphics for one circumferential portion be drawn with as thick a line as possible, the oscillation in the radial direction of that optical spot is such that the optical spot is oscillated in the radial direction as the optical disc DK rotates, for example, construction is feasible in which the optical spot oscillates an amount of 4.25 wavelengths per rotation of the optical disc DK.

In addition, when drawing a graphic while there is oscillation in the radial direction of the optical spot, that wavelength is not an integral multiple of one rotation of the optical disc DK, so there are positions where the track of the optical spot for the previous circumferential portion and the track of the current circumferential portion overlap and do not overlap within that one circumferential portion. Therefore, this means that the number of times overrecording is performed will differ according to the position in the one circumferential portion at the same radial position of the label surface, so as was described above, taking into consideration the oscillation frequency when setting the maximum number of times graphics will be drawn is effective in further stabilizing each kind of servo control.

### (II) Second Embodiment

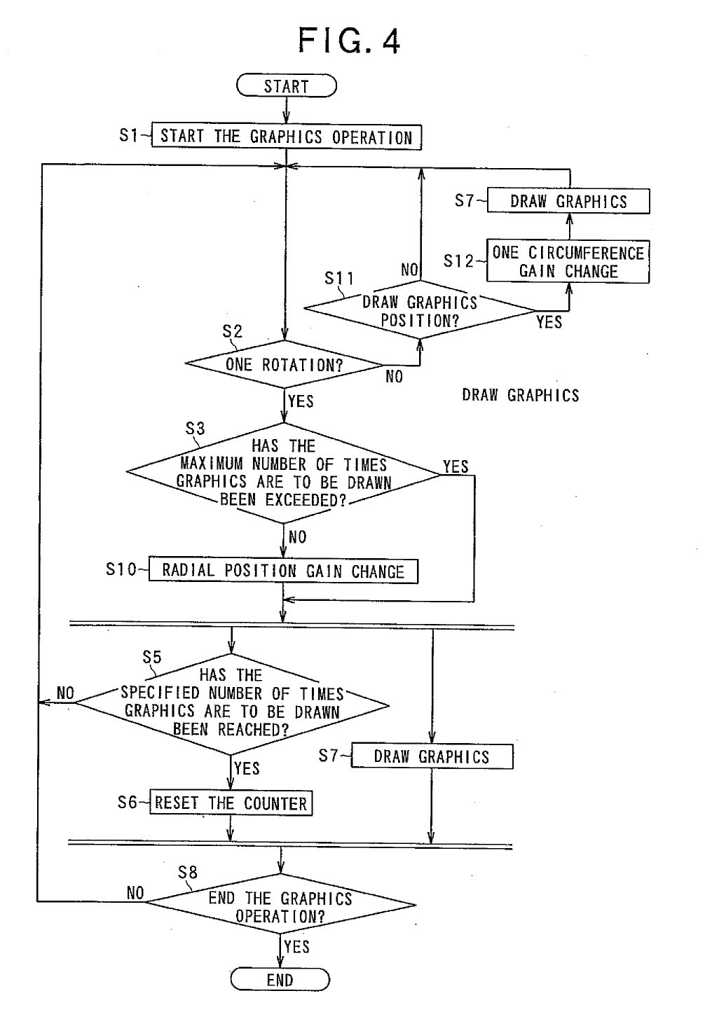

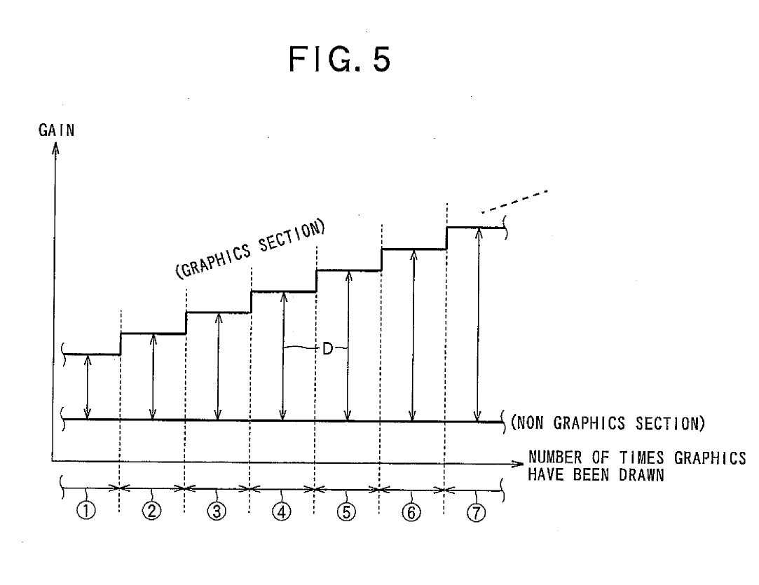

Next, another embodiment, or second embodiment, of the present invention will be explained using FIG. 4 and FIG. 5. FIG. 4 is a flowchart showing the operation of the graphics drawing device, and FIG. 5 is a drawing that conceptually shows the operation of that graphics drawing device.

The construction of the graphics drawing device of this second embodiment is the same as the construction of the graphics drawing device of the first embodiment, so a detailed explanation will be omitted. Also, in the flowchart shown in FIG. 4, processes that are the same as the processes in the flowchart shown in FIG. 2 are given the same step number, and a detailed explanation of them will be omitted.

In the first embodiment described above, the case was explained in which the gain was changed with a circumferential portion at a radial position being the unit of change, however, in the second embodiment described below, that circumferential portion is further broken down according to the contents of the imaged to be drawn on the label surface, and is an embodiment for the case in which the graphics operation is executed by classifying positions in that circumference where an image is drawn and not drawn.

As shown in FIG. 4, in the graphics operation of a second embodiment of the invention, processing that is the same as the processing of steps S1 to S8 of the first embodiment described above is executed. When doing this, the graphics operation of this second embodiment is unique in that instead of the gain change in step S4 described above, gain change that is suitable to one circumferential portion at the same radial position of the optical disc DK is executed (step S10).

On the other hand, the graphics operation of this second embodiment is unique in that, in the judgment of step S2 described above, when the drawing of graphics for one rotation portion has not yet been completed (step S2: NO), then next, whether or not the irradiation position of the light beam B has reached the segmented graphics position inside that one circumferential portion is determined based on a rotation angle signal Sfg that is output from the spindle motor 1 (step S11). When the irradiation position of the light beam B has not yet reached the graphics position (step S11: NO), processing moves to step S2, and the optical disk DK continues to rotate and the light beam B continues to be irradiated, however, when the irradiation position of the light beam has reached the graphics position (step S11: YES), gain change having a preset width is performed for that graphics position (in other words, gain change having a preset width is performed just at the position where a graphic is to be drawn in that one circumference) (step S12), and while that changed gain is used to perform focus servo control and tracking servo control, drawing is performed at that graphics position on that one circumferential portion (step S7), then processing returns to step S2.

As shown in FIG. 5, by executing this segmented gain change inside one circumference as explained above, and by totaling the number of times that overrecording has been performed (number of times graphics are drawn), it is possible to select the proper gain by correctly classifying each portion on the label surface even though the gain difference D that corresponds to the gain difference between the portion on the label surface where graphics are to be drawn and the portion where graphics are not to be drawn increases, and clear images are drawn at portions where graphics are to be drawn as in the case of the first embodiment.

As was explained above, with the operation of the graphics drawing device of this second embodiment, in addition to the advantages of the operation of the graphics drawing device SB of the first embodiment, the gain is changed to correspond to the number of times that overrecording has been performed at a position in one circumferential portion at the same radial position of the optical disc DK, so by controlling the gain in more detail inside one circumferential portion, more stable graphics control is possible, and as a result the graphics system is improved.

In the second embodiment described above, one circumferential portion at the same radial position on the label surface of an optical disc DK was classified into portions where graphics are to be drawn and not drawn, and the gain was changed accordingly, however, in addition to this, construction is possible in which the gain is kept constant inside one circumferential portion at the same radial position, however, the gain is changed in stages in order that the value of that gain is a value between the value of the gain corresponding to portions where graphics are to be drawn and the value of the gain corresponding to portions where graphics are not to be drawn.

Moreover, in the two embodiments described above, the number of rotations of the optical disc DK itself was used as an indicator for detecting the recording state (number of times overrecording is performed) on the label surface of the optical disc DK, however, in addition to this, construction is possible in which change in intensity of the reflected light of the light beam B itself (see the top of FIG. 3) is detected directly, and the gain is changed according to that change.

In this case, the gain is changed according to the intensity of reflected light that changes according to the number of times overrecording is performed at the same radial position of the optical disc DK (first embodiment) or for a recording position within the same radial position (second embodiment), so it is possible to properly change the gain according to the actual change in intensity of the reflected light and to stabilize the servo control.

Moreover, in the embodiments described above, the case in which the present invention was applied to a graphics drawing device that draws images on a label surface of an optical disc DK was explained, however, in addition to this, the present invention could also be applied to servo control for the case in which writing is performed a plurality of times on one recording track on the information recording surface of the optical disc DK.

Furthermore, it is possible to record a program that corresponds to the flowchart shown in FIG. 2 or FIG. 4 on an information-recording medium such as a flexible disc or hard disc, or to obtain the program via the Internet and record it, then by reading and executing that program by a general-purpose computer, cause that computer to function as the CPU 8 of the embodiments.

1. A servo control device that performs servo control of overrecording at the same position on a recording medium, comprising
a gain change device for changing the gain during the servo control to correspond with the status of the overrecording on the recording medium.

2. The servo control device of the claim 1, wherein
the recording medium is an optical recording medium, and
the gain change device changes the gain of an error signal, which is generated based on an optical beam that is reflected from the recording medium of an optical beam that is used for at least recording information to the optical recoding medium or reproducing information from the optical recoding medium and which is used in the servo control, according to the status of the overrecording.

3. The servo control device of claim 2, wherein
the gain change device changes the gain so that the amplitude of the error signal is fixed even though the status of the overrecording changes.

4. The servo control device of claim 1, wherein
the status of the overrecording is the number of times that overrecording is performed over the same position; and
the servo control device further comprises a counting device for counting the number of times that overrecording is performed over the same position; wherein
the gain change device changes the gain based on the counted number of times.

5. The servo control device of claim 4, wherein
the gain change device keeps the value of the gain fixed at the value of the gain that corresponds to a maximum number of times that overrecording is performed when the overrecording is executed a number of times that is greater than the maximum number of times that overrecording is performed, which is a maximum number of times that is preset according to the recording medium.

6. The servo control device of claim 2, wherein
the status of the overrecording is the intensity of the reflected beam that changes according to the number of times that overrecording is performed over the same position.

7. The servo control device of claim 1, wherein
the recording medium is a circular disc shaped recording medium; and
the same position is a same radial position on the recording medium.

8. A servo control method for controlling an overrecording
operation over a same position on a recording medium, comprising
a gain change process that changes the gain in the servo control to correspond to the status of the overrecording on the recording medium.

9. A servo control program that causes a computer to function as the servo control device of claim 1.
